(19) United States
(12) Patent Application Publication
(10) Pub. No.: US 2013/0313401 A1
(43) Pub. Date: Nov. 28, 2013

(54) ANTENNA HOLDING DEVICE

(71) Applicants: HONG FU JIN PRECISION INDUSTRY (Shenzhen) CO., LTD., (US); HONG HAI PRECISION INDUSTRY CO., LTD., New Taipei (TW)

(72) Inventor: YONG-SHENG YANG, Shenzhen (CN)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 13/718,567

(22) Filed: Dec. 18, 2012

(30) Foreign Application Priority Data
May 23, 2012 (CN) 201220233228.1

(51) Int. Cl. H01Q 1/12; F16M 11/20

(52) U.S. Cl. CPC H01Q 1/12; F16M 11/20
USPC 248/651; 248/176.3

(57) ABSTRACT

An antenna holding device for holding test antennas includes a base, a column, a sliding block and an antenna pole. The column is mounted on the base. The sliding block is slidably attached to the column. The antenna pole is mounted to the sliding block. A shielding layer is positioned on the base for preventing electromagnetic waves from the base to be absorbed by the test antennas.

### BACKGROUND

1. Technical Field

The present disclosure relates to antenna holding devices, and particularly to an antenna holding device for electromagnetic measurements.

2. Description of Related Art

In electromagnetic measurements, such as electromagnetic interference and site voltage standing-wave ratio measurements, various kinds of test antennas may need to be respectively mounted on an antenna holding device to transmit and/or receive test signals. However, conventional antenna holding device includes motors and a base made of ferrum. The motors and the base might emit electromagnetic waves to interfere with the tested antennas. This will affect the electromagnet measurement results.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a schematic view of an antenna holding device without a shielding layer, according to an exemplary embodiment.

FIG. 2 is a schematic view of the antenna holding device with the shielding layer.

### DETAILED DESCRIPTION

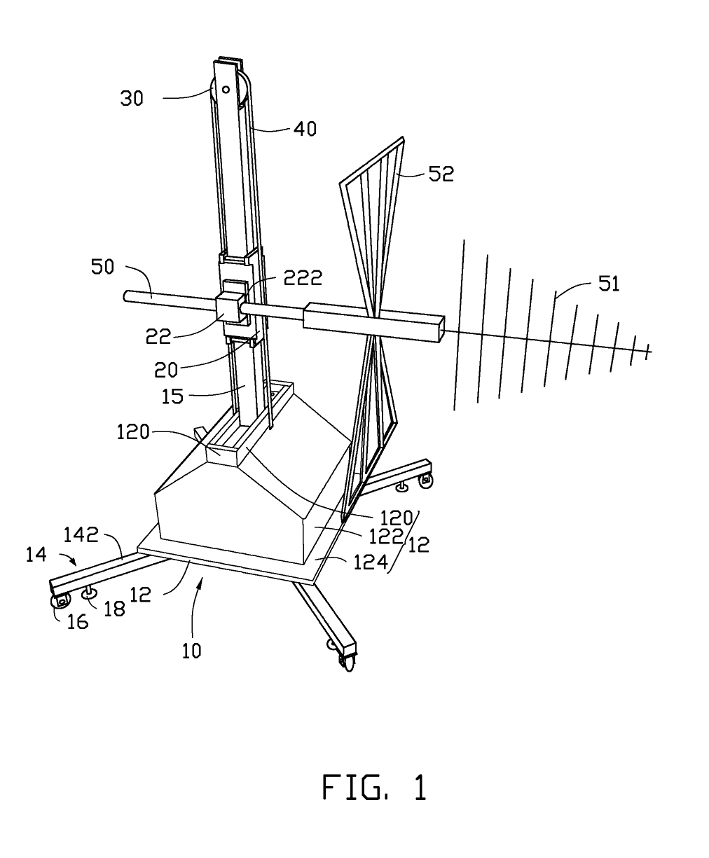

FIG. 1 shows an antenna holding device 100, according to an exemplary embodiment. The antenna holding device 100 can be used to simultaneously hold various test antennas for electromagnetic measurements, such as electromagnetic interference (EMI) and site voltage standing-wave ratio (SVSWR) measurements. In this embodiment, a first test antenna 51 and a second test antenna 52, which are different kinds of antennas, can be together held on the antenna holding device 100.

The antenna holding device 100 includes a base 10, a column 15, a sliding block 20, a driven wheel 30, a transmission belt 40, and an antenna pole 50.

The base 10 includes a case 12, a holder 14, a plurality of wheels 16, and a plurality of support feet 18. The case 12 is configured for receiving motors and other elements (not shown) therein. In this exemplary embodiment, the case 12 includes a top frame 120, a peripheral wall 122, and a peripheral flange 124 that are integrally formed together. The holder 14 is substantially cross-shaped and mounted under the case 12. The holder 14 includes four beams 142, that are joined together, the wheels 16, and the support feet 18; which are all mounted on undersides of the beams 142. In this embodiment, each of the beam 142 has one wheel 16 and one support foot 18 correspondingly mounted on the underside of the beam 142. The four wheels 16 are respectively rotatably mounted on four distal ends of the beams 142, and thus the holder 14 and the case 12 can be horizontally moved due to rotation of the wheels 16. Each of the support feet 18 is positioned adjacent to a corresponding one of the wheels 16, for retaining the holder 14 on predetermined locations. The support feet 18 are able to extend from and retract into the holder 14. In this way, the support feet 18 can retract to allow the wheels 16 to make contact with the ground and roll on the ground when the holder 14 needs to be moved. Additionally the support feet 18 can be retracted to hold the holder 14, when the holder 14 needs to be stationary.

One end of the column 15 is mounted into the case 12 from the top frame 120. The sliding block 20 is slidably attached to the column 15. The sliding block 20 includes a knuckle 22, defining a through hole 222. The antenna pole 50 extends through the through hole 222 for mounting the antenna pole 50 on the sliding block 20. The driven wheel 30 is rotatably mounted to another end of the column 15. The transmission belt 40 is coiled around the driven wheel 30 and extends along the column 15 until the transmission belt 40 is fitted in the case 12. A part of the transmission belt 40 is mounted with the sliding block 20. When the transmission belt 40 is driven to rotate, the sliding block 20 can slide along the column 15. The sliding block 20 further raises or lowers the antenna pole 50 for adjusting the height of the tested antennas 51 and 52.

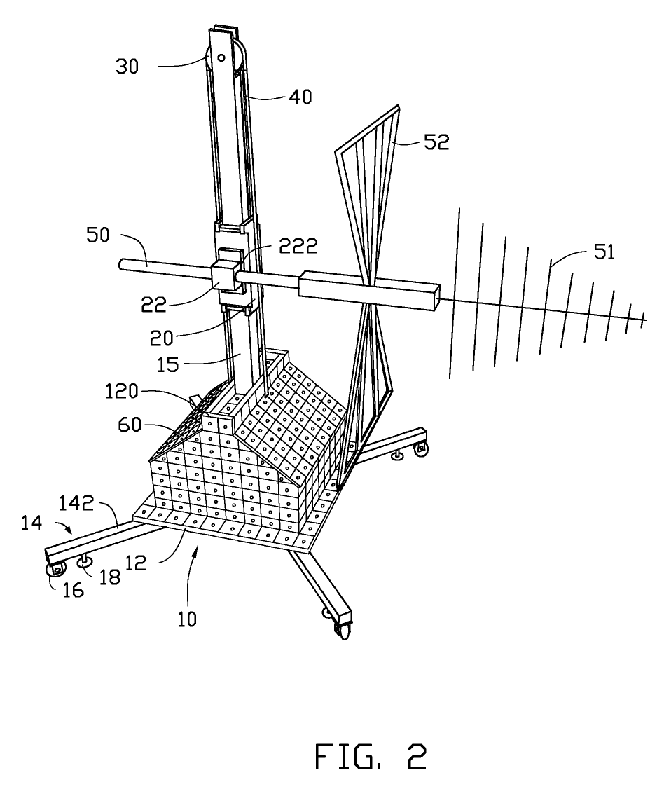

Referring to FIG. 2, a shielding layer 60 is located on the case 12. In this exemplary embodiment, the shielding layer 60 is made up of rectangular sheets 62. Each sheet 62 is made of ferrosoferric oxide (Fe₃O₄). In the exemplary embodiment, the rectangular sheets 62 are mounted on the top frame 120, the peripheral wall 122 and the peripheral flange 124 with screws. The rectangular sheets 62 are configured for absorbing electromagnetic waves from the case 12 and the motor in the case 12.

In use, test antennas, such as the first test antenna 51 and the second test antenna 52, are mounted on the antenna pole 50 and electrically connected to a common processor (not shown), such as a personal computer or a single chip computer. In the embodiment, the first test antenna 51 is a fishbone antenna, and the second test antenna 52 is a bow-tie antenna. According to known characteristics of these kinds of antennas, signal transmission and reception of fishbone antennas and bow-tie antennas generally do not interfere with each other. Therefore, the first test antenna 51 and the second test antenna 52 are mounted on the antenna pole 50.

The antenna holding device 100 with the mounted first and second test antennas 51 and 52 is then placed on a selected electromagnetic measuring location, and the wheels 16 of the whole antenna holding device 100 is rotated to position a selected one of the test antennas 51 and 52 towards a predetermined measuring direction for transmitting and/or receiving test signals. The sliding block 20 is driven to slide along the column 15, when the transmission belt 40 rotates along the driven wheel 30, thereby adjusting the first test antenna 51 and the second test antenna 52 to a predetermined height. Thus, the first test antenna 51 and the second test antenna 52 can be used in electromagnetic measurements. During the electromagnetic measurements, the electromagnetic shielding layer 60 can absorb electromagnetic waves, and may prevent the electromagnetic waves emitted by the case 12 or the elements in the case 12 from being transmission and reception by the first test antenna 51 and the second test antenna 52, and vice versa.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An antenna holding device for holding test antennas, comprising:
a base;
a column mounted on the base;
a sliding block slidably attached to the column; and
an antenna pole mounted to the sliding block;
wherein a shielding layer is positioned on the base and configured to prevent electromagnetic waves from the base to be transmitted and received by the test antennas.

2. The antenna holding device as claimed in claim 1, wherein the shielding layer is made up of sheets, and each rectangular sheet comprises ferrosoferric oxide.

3. The antenna holding device as claimed in claim 2, wherein the sheets are mounted on the base with screws.

4. The antenna holding device as claimed in claim 1, further comprising a driven wheel and a transmission belt, wherein the driven wheel is rotatably mounted on the column, the transmission belt is coiled on the driven wheel and extends along the column, and a part of the transmission belt is attached on the sliding block.

5. The antenna holding device as claimed in claim 1, wherein the sliding block comprises a knuckle defining a through hole, and the antenna pole extends through the through hole, for mounting the antenna pole on the sliding block.

6. An antenna holding device for holding test antennas, comprising:
a base comprising a case and a holder mounted under the case;
a column mounted on the case;
wherein a shielding layer is positioned on the case of the base and configured to prevent electromagnetic waves from the case to be transmitted and received by the test antennas.

7. The antenna holding device as claimed in claim 6, further comprising a driven wheel, a sliding block, and a transmission belt, wherein the driven wheel is rotatably mounted on the column, the sliding block is slidably attached to the column, the transmission belt is coiled on the driven wheel and extends along the column, and a part of the transmission belt is attached on the sliding block.

8. The antenna holding device as claimed in claim 7, wherein the shielding layer is made up of sheets, and each rectangular sheet comprises ferrosoferric oxide.
